(19) United States
(12) Patent Application Publication
(10) Pub. No.: US 2009/0260461 A1
(43) Pub. Date: Oct. 22, 2009

(54) ACTUATOR WITH ZERO POINT INITIALIZATION

(75) Inventors: Lawrence Edward Parker, Castaic, CA (US); Delton Boardman, Acton, CA (US)

Correspondence Address: Bainwood, Huang & Associates, LLC, 2 Connector Road, Westborough, MA, 01581, US

(73) Assignee: HR TEXTRON INC., Santa Clarita, CA (US)

(21) Appl. No.: 12/103,949

(22) Filed: Apr. 16, 2008

(51) Int. Cl. F16H 27/02; G06F 19/00

(52) U.S. Cl. 74/89.23; 700/302; 700/282; 700/275

(57) ABSTRACT

The actuator has a shaft having a starting point resistance feature, and a low resistance portion. The actuator has a motor configured to rotate the shaft, the motor outputting a current feedback signal to indicate current exiting the motor. The actuator has a interference portion in proximity to the shaft, the interference portion configured to facilitate a resistance to shaft rotation when the shaft rotates, the resistance to shaft rotation causing a magnitude of the current signal to be greater when the starting point resistance feature passes in front of the interference portion than when the low resistance portion passes in front of the interference portion.

### BACKGROUND

Actuators are used to allow mechanical devices to achieve motion such as rotational motion and linear motion. For example one conventional actuator used to achieve linear motion is a bolt and screw actuator. A bolt and screw actuator transforms rotational motion from a motor such as a simple electric motor into linear motion. The screw portion of the bolt and screw actuator is a threaded shaft that is rotated by the motor. The bolt portion of the bolt and screw actuator is a hollow cylinder with a threaded inner surface that matches with the threaded shaft. Rotation of the screw portion as it engages the bolt portion creates linear motion along the axis of the bolt portion and screw portion.

Some actuators, such as the bolt and screw actuator, are regulated by an electronic controller. The controller sends and receives data with the actuator to permit controlled regulation. For example a controller can be used to control the distance or speed that an actuator will move.

Actuators used to provide motion in mechanical devices may need to be initialized to be in some specific position. Since actuators cannot by themselves sense the position that they are in, mechanical stops are typically used to physically block the motion of an actuator at a certain point to locate the position.

### SUMMARY

Unfortunately there are deficiencies to the above-described conventional approaches to using a mechanical stop to initialize an actuator in some specific position. For example, with such an approach the mechanical stop will prevent a wider range of motion that would have otherwise been possible if the mechanical stop was not there. For example if the mechanical stop were placed on the rotating element of a bolt and screw actuator, the possible rotation of the shaft would be less than 360°. Applications that would require more than 360° rotation would not be possible. This would require designers to make expensive modifications to certain applications to work with existing actuators.

Another deficiency to the above-described conventional approaches to using a mechanical stop to initialize an actuator in some specific position is the inability to differentiate between the mechanical stop and a physical jamming of the actuator. Both the actuator running into the mechanical stop and the physical jamming of the actuator results in a complete stop in the motion of the actuator. This creates a reliability concern since the actuator cannot be certain that it has initialized to the correct location or that it has jammed in some other location. This could result in fewer feasible applications of the actuators in systems that require a high degree of reliability.

Yet another deficiency to the above-described conventional approaches to using a mechanical stop to initialize an actuator in some specific position is the difficulty in knowing the actual position of the internal workings of the valve device module after the actuator package module is removed. One way to be sure where the valve elements are positioned is to incorporate a hardware-based indication on the interface parts between the two modules to determine orientation. This is expensive to fabricate and reduces universality of the actuator package. Another way to be sure where the valve elements are position is to remove the entire valve assembly from the system to visually verify the position of the valve device module internal elements before the actuator module is mated to it. This is an expensive and time consuming procedure that requires draining and opening of the system piping.

In contrast to the above-identified conventional approaches to using a mechanical stop to initialize an actuator in some specific position, an improved actuator initialization technique involves using a detent to provide a resistance to rotation but not stop rotation. Such a detent structure would not limit rotation of the shaft and would allow for rotations greater than 360°. Additionally since the initialization point in relation to the detent causing resistance does not stop rotation, a differentiation can be made between identifying when the actuator has been initialized and when the actuator has jammed. Additionally, since the detent is in a known location, the actuator package can be removed and replaced without removing the entire valve device from the system, thereby maintaining system integrity.

One embodiment is directed to an actuator. The actuator has a shaft having a starting point resistance feature, and a low resistance portion. The actuator has a motor configured to rotate the shaft, the motor outputting a current signal to indicate current exiting the motor. The actuator has a detent in proximity to the shaft, the detent configured to facilitate a resistance to shaft rotation when the shaft rotates, the resistance to shaft rotation causing a magnitude of the current signal to be greater when the starting point resistance feature passes in front of the detent than when the low resistance portion passes in front of the detent.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a perspective view of an electronic system having an actuator and a valve device.

FIG. 2 is a perspective view of the actuator of FIG. 1 with a fixed member interacting with a shaft.

FIG. 3 is a cross section side view of a portion of the electronic system of FIG. 1 when the fixed member having a ball and a spring, engages the shaft.

FIG. 4 is a cross section top view of a portion of the electronic system of FIG. 1 when the motor having a set of poles and a set of hall sensors, engages the controller having a flash storage.

FIG. 5 is a chart representing four distinct current feedback signal measurements that can be identified by the electronic system.

### DETAILED DESCRIPTION

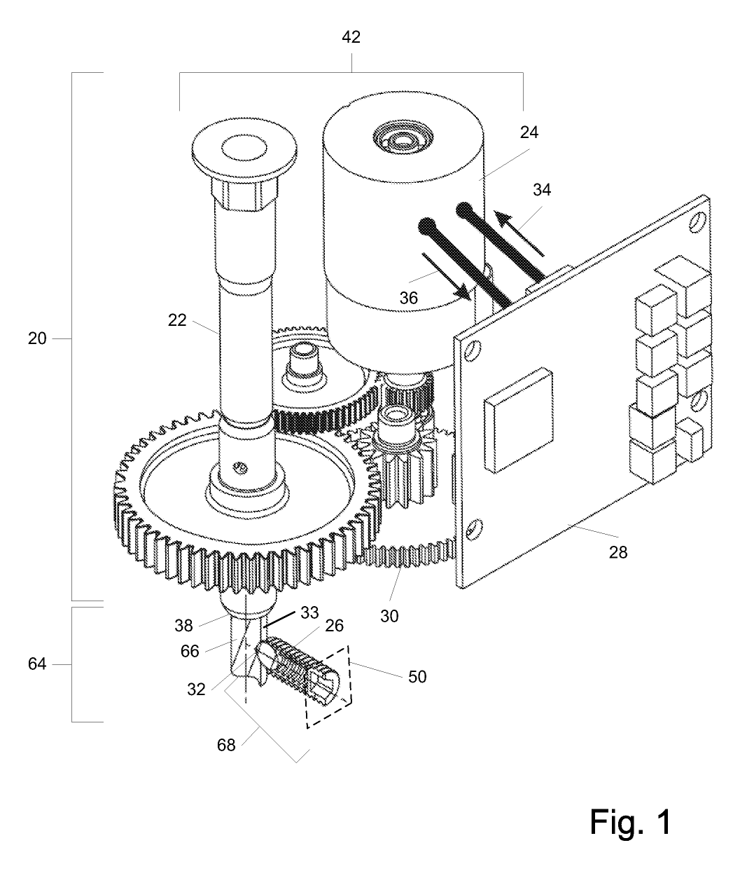

An improvement to an actuator assembly replaces the need for a mechanical stop to initialize the actuator with a resistance causing detent. Accordingly, the actuator preserves its full range of motion. The resistance causing detent can be incorporated into the actuator assembly in at least two different orientations. As will be described in further detail in FIG. 1, one orientation incorporates the resistance causing detent into a valve device.

FIG. 1 shows an electronic system 20 which includes a controller 28, and an actuator 42. The actuator 42 includes a motor 24 to power a rotatable shaft 22 which interfaces with valve device 64. As will be explained in further detail shortly, the rotatable shaft 22 interfaces with a rotatable shaft 66 of the valve device 64 at a shaft interface 38. A resistance portion 32 (e.g., an indentation) on the rotatable shaft 66 interfaces with a fixed member 68. An anchoring region 50 and an interference portion 26 (e.g., a spring loaded protrusion) form the fixed member 68. It should be understood that a gear assembly 30 is illustrated as an arrangement of integrated gears (e.g., a gear box) by way of example only, and that other arrangements for the gear assembly 30 are suitable for use as well. The electronic system 20 interfaces with other devices via the shaft interface 38 on the shaft 22. The controller 28 has integrated motor 24 current sensing capability. The shaft 22, the motor, and the gear assembly 30 form the core components for an actuator 42. The fixed member 68, the shaft 66, and resistance portion 32 form the valve device 64.

During operation, the controller 28 is arranged to provide a drive signal 34 to the motor 24, and sense the motor current and a Hall Effect feedback signal 36 from the motor 24. In response to the drive signal 34, the motor 24 drives the gear assembly 30 causing the rotatable shafts 22 and 66 to rotate in a particular direction (e.g., clockwise). As the rotatable shafts 22 and 66 turn, the resistance portion 32 periodically passes by the interference portion 26 of the fixed member 68 placing increased mechanical resistance or drag on the motor 24 and a changing in the current sensed by the controller 28. Such operation enables the controller 28 to determine a consistent initial position (i.e., a zero position) of the gear assembly 30. Nevertheless, the rotatable shaft 22 is able to freely rotate through the additional mechanical resistance without encountering a hard stop. As a result, the rotatable shafts 22 and 66 enjoy a wider range of motion.

In some arrangements, the drive signal 34 is an electric current which drives the motor 22. In these arrangements, the direction of the electric current determines the direction of rotation of the rotatable shafts 22 and 66. Furthermore, while the uniform portion of the rotatable shaft 22 passes by the interference portion 26, the sensed magnitude of the current is substantially uniform and at a relatively low level. However, when the resistance portion 32 of the rotatable shaft 22 engages with the interference portion 26, the sensed magnitude of the current increases thus enabling the controller 28 to detect when the particular angular displacement/position of the rotatable shaft 22, i.e., the zero position. Moreover, now that the behavior of the current is known, the controller 28 is capable of factoring in this behavior to mask out or ignore further encounters if the rotatable shaft 22 needs to rotate more than 360 degrees. Further details will now be provided with reference to FIG. 1.

As shown in FIG. 1, the shaft 22 acts through the shaft interface 38 to provide mechanical motion for connected devices (e.g. valves). The mechanical motion can be in many forms including but not limited to rotational motion (e.g. provided by a solid shaft 22) and linear motion (e.g. provided by a screw and bolt shaft 22). In one embodiment the shaft 22 is directly rotated by the motor 24. Alternatively in another embodiment, the shaft 22 is rotated at a different speed than the motor 24 if it is connected by the gear assembly 30. High reduction gearboxes 30 allows for smaller motors 24 with higher torques.

As shown in FIG. 1, the interference portion 26 engages the shaft 66 as the shaft 66 rotates. As the resistance portion 32 passes in front of interference portion 26, there is an increase to the resistance of rotation of the shaft 66. There is also resistance to rotation caused by the interference portion 26 when other areas of the shaft 66 pass in front of the interference portion 26, but the magnitude of this resistance is less than in the previous scenario.

The current usage level of the motor 24 is sensed by the controller 28 and corresponds to resistance to shafts 22 and 66 rotation powered by the motor 24. The controller 28 is able to differentiate between four discrete current levels. The lowest magnitude of the current corresponds to the operating current necessary to move the shafts 22 and 66 during normal operation (i.e. when areas other than the resistance portion 32 passes in front of interference portion 26). The low intermediate magnitude of the current corresponds to the breakout current which includes additional current draw caused by “sticktion” of the seals and bearings that occurs when the shafts 22 and 66 first start to move. The high intermediate magnitude of the current corresponds to the increase in resistance to shafts 22 and 66 rotation when the resistance portion 32 passes in front of interference portion 26. The highest magnitude of the current corresponds to a shaft rotation that is frozen or jammed.

As shown in FIG. 1, the drive signal 34 is a signal from the controller 28 that gives operating instructions to the motor 24. When initial power is applied to the actuator 42, the controller 28 sends the drive signal 34 to instruct the motor 24 to rotate. If the controller 28 receives the discrete high intermediate magnitude of the current signaling that the resistance portion 32 passed in front of the interference portion 26, the controller 28 will signal the motor 24 to reverse rotation a set number of rotational counts to return to the required mechanical zero. Conversely, if the controller 28 receives the discrete highest magnitude of the current signaling that shaft 22 rotation has frozen or jammed, the controller 28 will signal the motor to draw less current to prevent overheating.

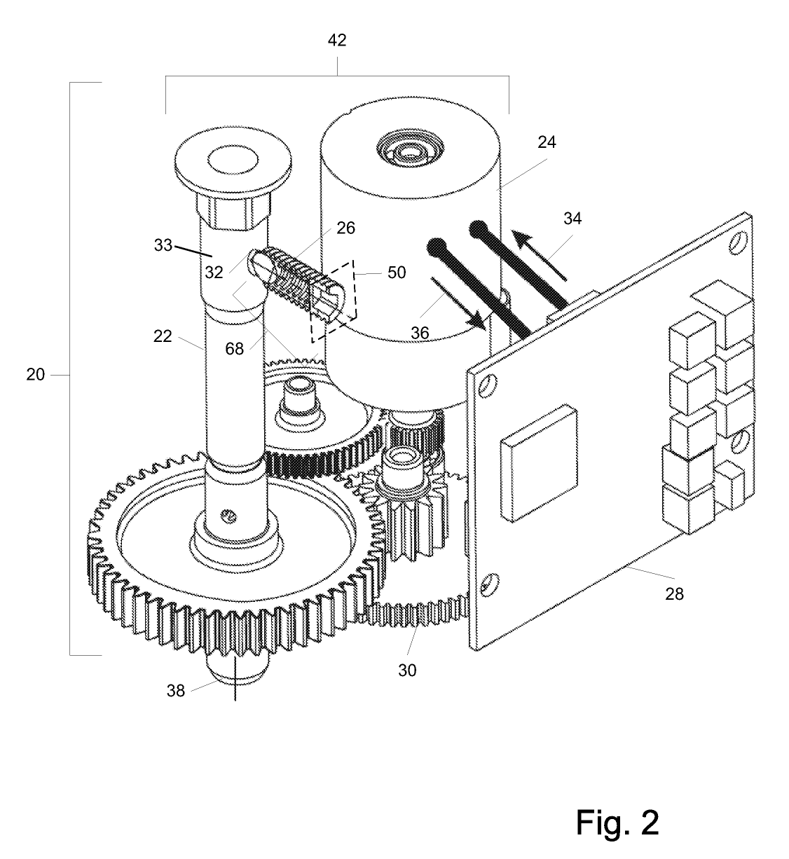

This orientation incorporating the resistance causing detent into the valve device 64 allows the actuator 42 to be used with existing valve devices 64 that have the interference portion 26 and with new valve devices 64 designed with the interference portion 26. As will be described in further detail in FIG. 2, another orientation incorporates the resistance causing detent into the actuator 42.

FIG. 2 shows the electronic system 20 which includes the controller 28, and the actuator 42. The actuator 42 includes a motor 24 to power the rotatable shaft 22 which interfaces with the valve device 64 (not shown in FIG. 2). As will be explained in further detail shortly, the rotatable shaft 22 has the resistance portion 32 (e.g., an indentation) that interacts with fixed member 68. The anchoring region 50 and the interference portion 26 (e.g., a spring loaded protrusion) form the fixed member 68. It should be understood that the gear assembly 30 is illustrated as an arrangement of integrated gears (e.g., a gear box) by way of example only, and that other arrangements for the gear assembly 30 are suitable for use as well. The electronic system 20 interfaces with other devices via the shaft interface 38 on the shaft 22. The controller 28 has integrated motor 24 current sensing capability. The shaft 22, resistance portion 32, the motor, the gear assembly 30, and the fixed member 68 form the core components for an actuator 42.

The fixed member 68 interacts with the resistance portion 32 on shaft 22 in the same way as previously described with the resistance portion 32 on shaft 66 (See FIG. 1). In this orientation, the actuator 42 can interact with existing valve devices 64 that do not have the interference portion 26 or for valve device 64 designs that have space limitations that preclude having the interference portion 26. In some arrangements, the interference portion 26 is designed to be removable to allow the use of the actuator 42 in multiple applications.

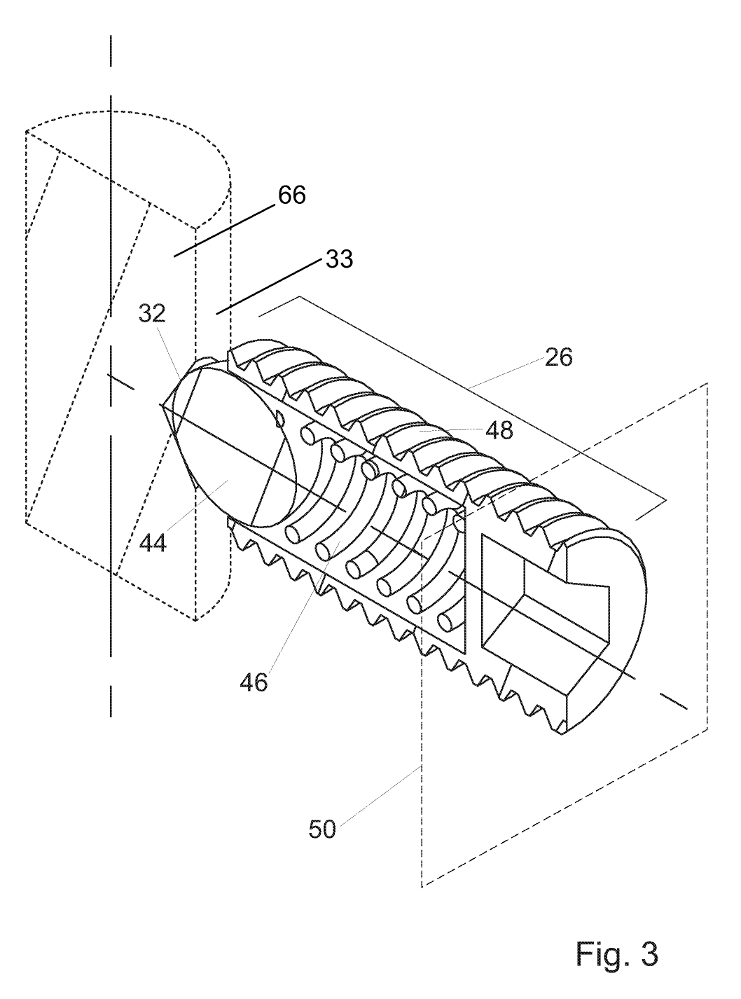

FIG. 3 shows the interference portion 26 engaging the shaft 66 at the resistance portion 32. The interference portion 26 is composed of a ball 44, a spring 46, and a protrusion chamber 48. The interference portion 26 is rigidly attached to the anchoring region 50.

As shown in FIG. 3, one possible configuration for the interference portion 26 is the ball 44 interference portion 26 with spring 46 loading. The ball 44 freely rotates at the end of the chamber 48. The ball 44 can be pushed further into the protrusion chamber 48, but cannot fall out of the chamber 48. The ball 44 is pushed to the end of the protrusion chamber 48 by the spring 46 disposed inside of the chamber. There are other types of interference portion 26 configurations possible such as a wheel or solid interference portion 26 that may be used in other embodiments.

As shown in FIG. 3, one possible configuration of the resistance portion 32 is an indentation 32. The indentation 32 works well with the ball 44 interference portion 26 with spring 46 loading formation of the interference portion 26. The indentation 32 is large enough for the ball 44 to fall into. Other types of starting point resistance features 32 such as a protrusion, vertically oriented slot, such as for a keyway, or adhesive area may be used in other embodiments.

As shown in FIG. 3, one possible configuration of the spring 46 is the adjustable spring 46. The adjustable spring 46 allows the spring constant to be tuned so that the high intermediate magnitude of the current feedback signal 40, corresponding to the increase in resistance to shaft 22 rotation when the resistance portion 32 passes in front of interference portion 26, can yield a specific motor current level.

As shown in FIG. 3, the ball 44 of the interference portion 26 rolls along shaft 66 as the shaft 22 rotates. When the ball 44 falls into the indentation 32 there is no significant increase resistance to shaft 22 rotation and thus no significant increase in current feedback signal 40. However, when the ball 44 moves out of the indentation 32, the ball 44 will push against the wall of the indentation 32. This will cause an increase in resistance to shaft 22 rotation and thus an increase in current level sensed by the controller 28. The increase in current followed by reduction of current to the normal operating level would be recognized by the controller 28 as the high intermediate magnitude of the current.

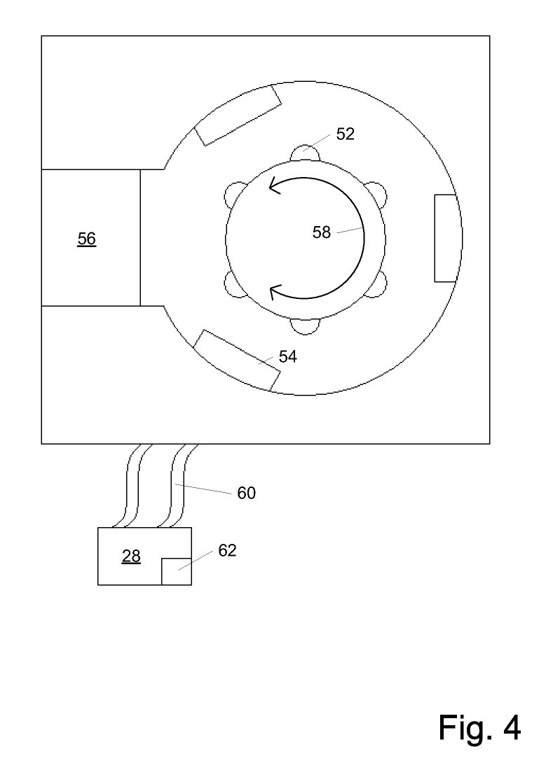

FIG. 4 shows the motor 24 connected to the controller 28. The motor 24 includes a set of poles 52 (i.e., two or more poles 52), a set of Hall Effect sensors 54 (i.e., one or more Hall Effect sensors 54), a magnet 56, a motor rotation 58, and a set of wires 60 (i.e., one or more wires). The controller 28 contains a flash storage 62.

As shown in FIG. 4 one possible configuration for the motor 24 is the brushless DC motor 24. The brushless DC motor 24 is a six pole 52 motor 24 that can rotate in both directions 58. The brushless DC motor employs three Hall Effect sensors 54. When this brushless DC motor 24 is used in conjunction with the 60:1 reduction gear assembly 30, rotations of the shaft 22 as small as ⅓ of a degree can be detected by the controller 28. There are other types of motors that may be used in other embodiments.

As shown in FIG. 4 the Hall Effect sensors 54 are used to identify when the pole 52 passes in front of the Hall Effect sensor 54 during motor rotation 58. When the Hall Effect sensor detects the pole 52 in front of it, the Hall Effect sensor sends the Hall Effect feedback signal 36 to the controller 28 over the set of wires 60. The controller 28 makes counts of the pole 52 passes by the Hall Effect sensors 54. The controller can use these counts to calculate discrete distances that the shaft 22 has rotated. The controller can also use these counts to instruct the motor 24 to rotate the shaft 22 discrete distances.

As shown in FIG. 4 the controller 28 utilizes the flash storage 62. The controller 28 can utilize the flash storage 62 record the count number. If there is a loss of external power, upon restoration of power, the controller can calculate the position of the shaft based on the stored count number assuming the shaft 22 has not been manually moved. The controller can then direct the motor 24 to rotate the shaft 22 to the approximate zero initialization point. The electronic system 20 can then initiate the startup sequence to use the interference portion 26 to find the true zero initialization point.

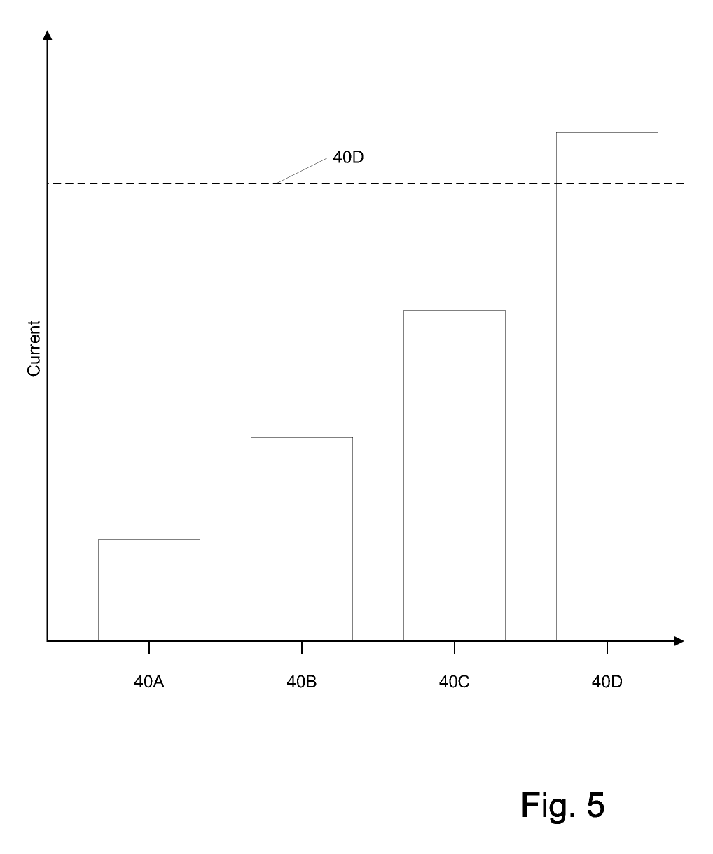

FIG. 5 shows various current signals 40 that are detected by the controller 28. The current signals include a normal operational current 40A, a breakout current 40B, a detent current 40C, and a jammed current 40D.

As shown in FIG. 5, the normal operational current 40A is the lowest current recognized by the controller 28. The normal operational current 40A will not cause the controller 28 to modify its instructions to the motor 24. The breakout current 40B is a slight increase over the normal operational current 40A that occurs when the shaft 22 first starts to rotate and has to overcome static friction. The detent current 40C is greater than the breakout current 40B but less than the jammed current 40D. The detent current indicates an increase in resistance to shaft 22 rotation when the resistance portion 32 passes in front of interference portion 26. Upon detecting the detent current 40C and the subsequent drop to operational current 40A, the controller 28 will signal the motor 24 to reverse rotation a set number of rotational counts to return to the required mechanical zero. If controller 28 is not in the initialization process, and the commanded actuator position is greater than 360°, the controller 28 will ignore the detent current 40C and continue to rotate to the commanded position. The jammed current 40D is the highest current recognized by the controller 28. The jammed current 40D is also represented as a threshold current. Thus any current greater than this threshold will be viewed as the jammed current 40D. If the controller 28 receives the jammed current 40D, the controller 28 will signal the motor to draw less current to prevent overheating.

While various embodiments of the invention have been particularly shown and described, it will be understood by those skilled in the art that various changes in form and details may be made therein without departing from the spirit and scope of the invention as defined by the appended claims.

For example, the interference portion 26 can provide a resistance to create the intermediate magnitude of the current feedback signal 40 by engaging the shaft 22 that is rotating or moving linearly.

In another example, the interference portion 26 and the resistance portion 32 are swapped. One embodiment of this example would have a spring 46 loaded ball 44 interference portion 26 attached to the rotating shaft 22. The protrusion would engage the resistance portion 32 in the form of the cavity formation 32 that is embedded in the anchoring region 50.

1. An actuator, comprising:
a shaft having:
a resistance portion, and
a substantially uniform portion;
a motor configured to rotate the shaft, the motor outputting a current signal to indicate current level supplied to the motor; and
an interference portion disposed on a member adjacent the shaft, the interference portion configured to facilitate a resistance to shaft rotation when the shaft rotates, the resistance to shaft rotation eliciting a magnitude of the current signal to be greater when the resistance portion passes in front of the interference portion than when the substantially uniform portion passes in front of the interference portion.

2. The actuator of claim 1 wherein the interference portion is a spring loaded ball interference portion having:
an interference portion chamber that attaches to an anchoring region;
a ball configured to roll on the surface of the shaft; and
a spring that connects the ball to the interference portion chamber, the spring applying a compression force on the ball.

3. The actuator of claim 1 wherein the resistance to shaft rotation causes the magnitude of the current signal to be less when the resistance portion passes in front of the interference portion than when shaft rotation jams.

4. The actuator of claim 1 wherein the motor has at least one Hall Effect sensor configured to count the rotations of the shaft.

5. The actuator of claim 2 wherein the actuator further comprises a gearbox configured to rotate the shaft at a different speed than the motor.

6. An electronic system, comprising:
a shaft having:
a resistance portion, and
a substantially uniform portion;
a motor configured to rotate the shaft, the motor outputting a current signal to indicate current level supplied to the motor;
an interference portion disposed on a member adjacent the shaft, the interference portion configured to facilitate a resistance to shaft rotation when the shaft rotates, the resistance to shaft rotation eliciting a magnitude of the current signal to be greater when the resistance portion passes in front of the interference portion than when the substantially uniform portion passes in front of the interference portion; and
a controller configured to (i) receive the current signal from the motor, (ii) selectively identify four different magnitudes of the current signal, and (iii) send a motor control signal to the motor.

7. The electronic system of claim 6 wherein the interference portion is a spring loaded ball interference portion having:
an interference portion chamber that attaches to an anchoring region;
a ball configured to roll on the surface of the shaft; and
a spring that connects the ball to the interference portion chamber, the spring applying a compression force on the ball.

8. The electronic system of claim 6 wherein the resistance to shaft rotation causes the magnitude of the current signal to be less when the resistance portion passes in front of the interference portion than when shaft rotation jams.

9. The electronic system of claim 6 wherein the motor has at least one Hall Effect sensor configured to count the rotations of the shaft.

10. The electronic system of claim 7 further comprising a gearbox configured to rotate the shaft at a different speed than the motor.

11. The electronic system of claim 9 wherein the motor is configured to send a Hall Effect sensor signal to the controller that indicates a count of the rotations of the shaft.

12. The electronic system of claim 11 wherein the controller has a flash storage configured to store the Hall Effect state count of the rotations of the shaft.

13. The electronic system of claim 6 wherein the motor control signal directs the motor to move a predefined amount to a zero point initialization when the controller identifies the magnitude of the current signal that corresponds to the resistance portion passing in front of the interference portion.

14. The electronic system of claim 8 wherein the controller is configured to send the motor control signal to reduce power to the motor to avoid overheating when the controller identifies the magnitude of the current signal that corresponds to shaft rotation jamming.

15. The electronic system of claim 11 wherein the controller, upon power failure and restoration to the electronic system, is configured to (i) calculate shaft position based on the Hall Effect State count of rotation of the shaft stored in the flash storage and (ii) send the motor control signal to send the shaft to a calculated zero point initialization.

16. An electronic system, comprising:
a first shaft having:
a resistance portion, and
a substantially uniform portion;
a second shaft attached to the first shaft at a shaft interface;
a motor configured to rotate the first shaft and the second shaft, the motor outputting a current signal to indicate current level supplied to the motor;
an interference portion disposed on a member adiacent the first shaft, the interference portion configured to facilitate a resistance to shaft rotation when the shaft rotates, the resistance to shaft rotation eliciting a magnitude of the current signal to be greater when the resistance portion passes in front of the interference portion than when the substantially uniform portion passes in front of the interference portion; and
a controller configured to (i) receive the current signal from the motor, (ii) selectively identify four different magnitudes of the current signal, and (iii) send a motor control signal to the motor.

17. The electronic system of claim 16 wherein the first shaft is a shaft of a valve device and the second shaft is a shaft of an actuator.

18. The electronic system of claim 16 wherein the first shaft is a shaft of an actuator and the second shaft is a shaft of a valve device.

19. The electronic system of claim 17 wherein the interference portion is a spring loaded ball interference portion having:
an interference portion chamber that attaches to an anchoring region;
a ball configured to roll on the surface of the shaft; and
a spring that connects the ball to the interference portion chamber, the spring applying a compression force on ball.

20. The electronic system of claim 17 wherein the resistance to shaft rotation causes the magnitude of the current signal to be less when the resistance portion passes in front of the interference portion than when shaft rotation jams.

21. The electronic system of claim 17 wherein the controller is configured to send the motor control signal to move the motor a predefined amount to a zero point initialization when the controller identifies the magnitude of the current signal that corresponds to the resistance portion passing in front of the interference portion.

22. A method for initializing an actuator comprising:
directing a motor to rotate a shaft having a resistance portion, and substantially uniform portion, the motor outputting a current signal to indicate current supplied to the motor; and
identifying when an interference portion passes in front of the resistance portion; and
causing resistance to rotation of the shaft by engagement of the interference portion with the resistance portion and the substantially uniform portion, the resistance to shaft rotation causing a magnitude of the current signal to be greater when the resistance portion passes in front of the interference portion than when the substantially uniform portion passes in front of the interference portion.
